(19) United States
(12) Patent Application Publication
(10) Pub. No.: US 2004/0205770 A1
(43) Pub. Date: Oct. 14, 2004

(54) Duplicate message elimination system for a message broker

(75) Inventors: Kai Mike Zhang, Lake Oswego, OR (US); Kenneth L. Astl, Castro Valley, CA (US); Subramanyam Agraharam Gooty, Fremont, CA (US); Arul Prabhu Sundaramurthy, Pleasanton, CA (US)

Correspondence Address: MICHAEL J. BUCHENHORNER, ESQ, HOLLAND & KNIGHT, 701 BRICKELL AVENUE, MIAMI, FL, 33131, US

(73) Assignee: International Business Machines Corporation, Armonk, NY

(21) Appl. No.: 10/364,738

(22) Filed: Feb. 11, 2003

(51) Int. Cl. G06F 3/00; G06F 13/00; H04K 1/00; H04L 9/00

(52) U.S. Cl. 719/313; 705/75

(57) ABSTRACT

A method for preventing the delivery of duplicate messages in a message system, wherein each message comprises a unique message identifier that identifies itself from adjacent messages, comprises the steps of polling a message store for messages directed to a specified receiver; receiving from the message store at least one message directed to the specified receiver; processing the at least one message; receiving, from a monitor queue, a message identifier for the last message successfully delivered to the specified receiver; and comparing the message identifier received from the monitor queue to the message identifier of the message received from the message store.

### FIELD OF THE INVENTION

The invention disclosed broadly relates to the field of information technologies, and more particularly relates to the field of messaging systems.

### BACKGROUND OF THE INVENTION

The diversity among different enterprise software applications has made enterprise application integration (EAI) a necessary part of the enterprise information technologies infrastructure and a critical component of such an infrastructure is the messaging system. A messaging system is software that provides an electronic mail delivery system. Internet e-mail is an example of a messaging system.

Present messaging systems endeavor to provide reliable message delivery mechanisms. See e.g., U.S. Pat. No. 6,256,676 issued to Taylor et al. It is a goal of these message delivery systems to provide reliable message delivery, making sure that messages are not lost, delayed, or duplicated. Many messaging systems try to address this problem by using asynchronous message delivery. This capability uses “store-and-forward” message queuing where a queue-to-queue transfer takes place in pseudo real-time when the receiving application is available to retrieve the message. If the receiving application is unavailable, the message is stored in a persistent queue for later delivery. IBM's widely-used MQSeries message queuing product employs this capability.

However, those present systems still experience detriments in message delivery. One such detriment is the problem of duplicate delivery of the same message under certain circumstances, such as after a network failure.

An illustration of a messaging system as discussed above is shown in FIG. 1. The messaging system 100 comprises a Message (or event) Store 102, a Message Transfer Agent (MTA) 106, and a Message Broker 104. The Message Broker 104 in this example is a Java Message Service (JMS) Server that receives messages 108 sent by the Message Store 102.

The Message Store 102 holds messages until they are selectively retrieved by the MTA 106. The Message Store 102 in turn comprises a plurality of stored source messages 108 (e.g., mail), and the Message Broker 104 comprises a destination queue 110.

The Message Store 102 is a persistent storage system for storing source messages (events) 108. It can be implemented as a JMS queue, a database table, a file-based store, or any other form of storage that is suitable for this purpose. The requirement is that it must be non-volatile storage, such as a hard drive.

A message 108 is an event that is being sent to the JMS Message Broker 104; it includes a unique identifier (e.g., a code) to identify itself from adjacent messages. The messages could be directed to a specific recipient (such as in e-mail messages), or the Message Broker 104 could determine one or more potential recipients for the message based on pre-established subscription rules. Two different methods for automatic message delivery are subject-based addressing and message-content filtering. A potential recipient (or subscriber) would need to register preferences with the Message Broker 104. For example, if subject-based addressing is employed, payroll would register to receive any messages with”new hire” in the subject.

The MTA 106 comprises computer logic for (1) polling the Message Store 102; (2) receiving a message 108 that is a subject of the poll; (3) processing the incoming message 108; (4) sending the message 108 to the Message Broker 104. The contract between the sender (Message Store 102) and the receiver (Message Broker 104) guarantees that a message 108 is to be delivered from the sender to the receiver once and only once. A common process for delivering messages currently used comprises the following steps, as shown in FIG. 2:

(1) In step 1, shown as block 201, the MTA 106 polls for a message or a message is dispatched to the MTA 106 through a callback procedure;

(2) In step 2, shown as block 202, the MTA 106 performs the logic discussed above on the message (i.e., the message is processed);

(3) In step 3, shown as block 203, the MTA 106 sends the message to the destination queue 110 in the JMS Broker 104;

(4) In step 4, shown as block 204, the MTA 106 sends an acknowledgement to the Message Store 102 that the message 108 has been successfully delivered to its recipient, resulting in the Message Store 102 removing the delivered message 108 from its queue.

This process guarantees that a message is never lost. However, it is flawed because the same message can be delivered two or more times to the same destination in the event of a network failure. For example, consider a situation where the system experiences a network failure between steps 3 and 4 above. In this scenario, the message 108 has already been processed and delivered to the Destination Queue 110; however, the acknowledgement has not yet been sent back to the Message Store 102. Therefore, the message is still retained in the Message Store 102 queue. This results in the message being sent or polled again when the MTA 106 is restarted after the network failure. This duplication could potentially be quite costly to a corporation. When one considers the number of mission critical messages traveling through the external and internal networks of today's business enterprises, it becomes apparent that there is a need for a system and method that avoids delivery of duplicate messages under more circumstances than present systems.

### SUMMARY OF THE INVENTION

Briefly, according to the invention, a message system for preventing the delivery of duplicate messages comprises a message broker that includes a destination queue for storing messages to be delivered to recipients (or subscribers) and a monitor queue for storing a unique identifier for the last message delivered successfully by the message broker to its recipient or recipients. The message system also comprises a message store for storing source messages received from their senders (or publishers). An agent is used to retrieve messages from the message store and to compare the unique message identifier of the retrieved message with a unique identifier obtained from the message broker for the last message successfully sent by the message broker (i.e., received by the intended recipient).

The message broker also includes logic (software, firmware, or hardware) for receiving messages sent by the message store. The agent acknowledges to the message store that the compared messages are the same and thus causes the message store to delete the received message from its storage so that it cannot be delivered again. Alternatively, if the agent determines that the compared message identifiers are not the same, it sends the message received from the message store to the destination queue for delivery to its recipient(s) and it also sends the message identifier for that message to the monitor queue, replacing the old message identifier.

### BRIEF DESCRIPTION OF THE DRAWINGS

FIG. 1 is an illustration of a messaging system according to the prior art.

FIG. 2 is a block diagram of the Message Transfer Agent's role in the messaging system, according to the prior art.

FIG. 3 is an illustration of a messaging system according to an embodiment of the present invention.

FIG. 4 is a flow diagram of the Message Transfer Agent's role in the messaging system, according to an embodiment of the invention.

FIG. 5 is a table illustrating the processing results for three different failure scenarios for the messaging system.

FIG. 6 is a basic block diagram of a hardware representation of an embodiment of the invention.

### DESCRIPTION OF A PREFERRED EMBODIMENT

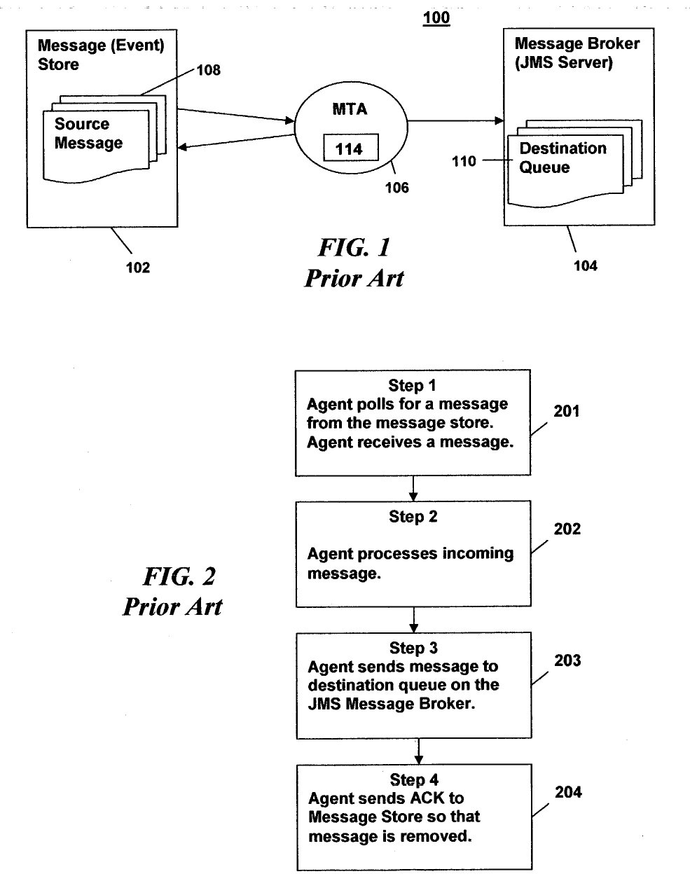

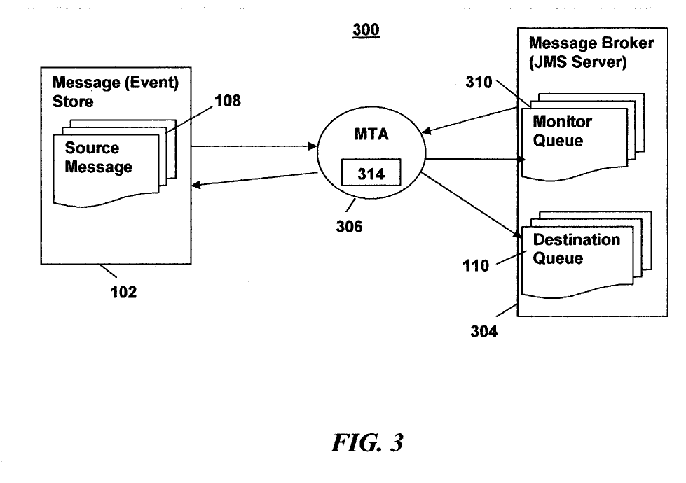

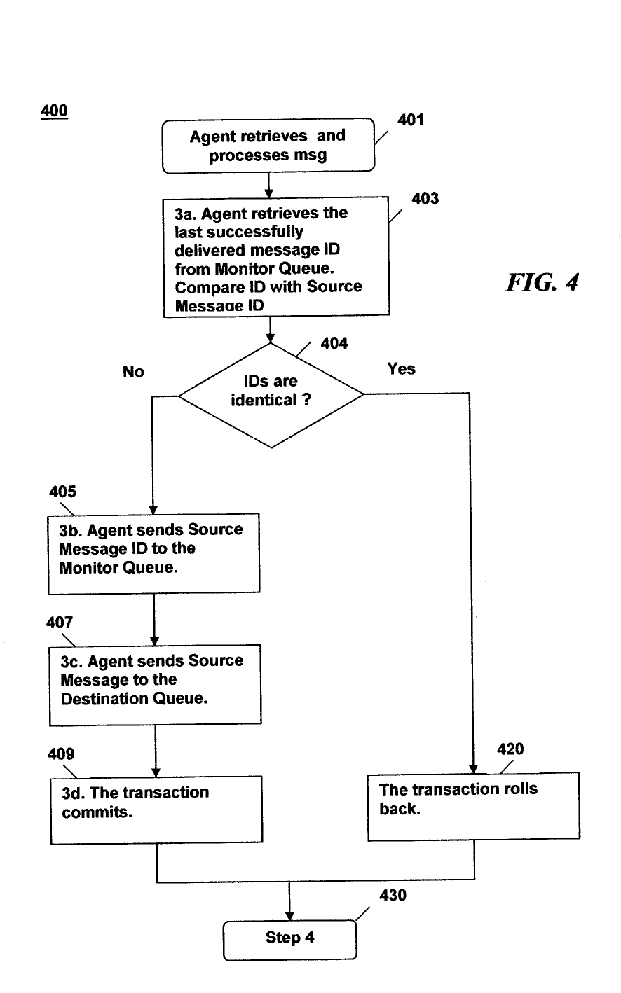

Referring to FIG. 3, there is shown a block diagram of a messaging system 300 according to an embodiment of the invention. It is similar to the system depicted in FIG. 1, with the Message Store 102, the messages 108, and the Destination Queue 110 remaining the same. The main difference in this messaging system 300, is the addition of a Monitor Queue 310 in the Message Broker 304, and the additional logic performed by the MTA 306, in step 314. Using the Monitor Queue 310, the MTA 306 in this system 300 will perform logic to prevent the loss of messages or the sending of duplicate messages in the event of a network failure, or crash, as follows.

The MTA 306 in the messaging system 300 will perform the following method steps in order to assure that no duplicate messages are delivered in the event of a network failure:

The transaction commences as in Steps 1 and 2 of FIG. 2, beginning at block 401. The MTA 306 polls for a message or a message is dispatched to the MTA 306 through a callback procedure. Next, the MTA 306 processes the message exactly as in Step 2 of FIG. 2. Up to this point the transaction steps are identical to those of FIG. 2.

Step 3 as shown in block 203 of FIG. 2 is now broken down into four steps, 3a, 3b, 3c, and 3d, as follows:

In Step 3a, as shown in block 403, the MTA 306 will access the Monitor Queue 310 to retrieve the unique message id from the last successfully delivered message. It will then compare that message id with the message id of the message 108 it retrieved from the Message Store 102. If the message ids are identical, as determined in block 404, this means that this current message is a duplicate and should not be delivered to the Destination Queue 110. Accordingly, the MTA 306 will skip Steps 3b, 3c, and 3d, thus causing the transaction to roll back in block 420 and go right to Step 4 in block 430 and send an acknowledgement to the Message Store 102 that this message has already been successfully delivered. This action will cause the Message Store 102 to remove the message 108 from its queue or otherwise tag the message so that it is not served again.

If, however, the message ids do not match in Step 3a, then the MTA 306 will go on to Step 3b, shown in block 405, and send the message id of this message 108 to the Monitor Queue 310. Processing will continue to Step 3c.

In Step 3c, shown as block 407, the MTA 306 will send the message 108 to the Destination Queue 110.

In Step 3d, shown as block 409, the MTA 306 performs a business transaction coordination function, also known as committing the transaction (explained below).

Step 4, shown as block 430, remains the same as in FIG. 2. The MTA 306 sends an acknowledgement (ACK) to the Message Store 102 confirming the successful delivery of the message 108. The Message Store 102, upon receipt of this ACK, will remove the message 108 from its queue. This will prevent the message 108 from being resent.

Many message delivery systems employ a business transaction coordination function as mentioned in step 3d above. A business transaction is made up of multiple units of work. The transaction is not committed (i.e., will not happen) until each of the units of work is completed. If even one unit of work fails, the whole transaction fails, and all completed units of work must be rolled back (reversed). In the above example, a comparison revealing matching message IDs would cause the MTA 306 to skip the step of committing the transaction. This causes the units of work which made up this transaction (sending message ID to Monitor Queue 310, sending message to Destination Queue 110) to be reversed.

The unique feature of this messaging system 300 is the use of a Monitor Queue 310 to store the message id of the last successfully delivered message. Without the implementation of the Monitor Queue 310 there would be no way to guarantee the elimination of duplicate messages.

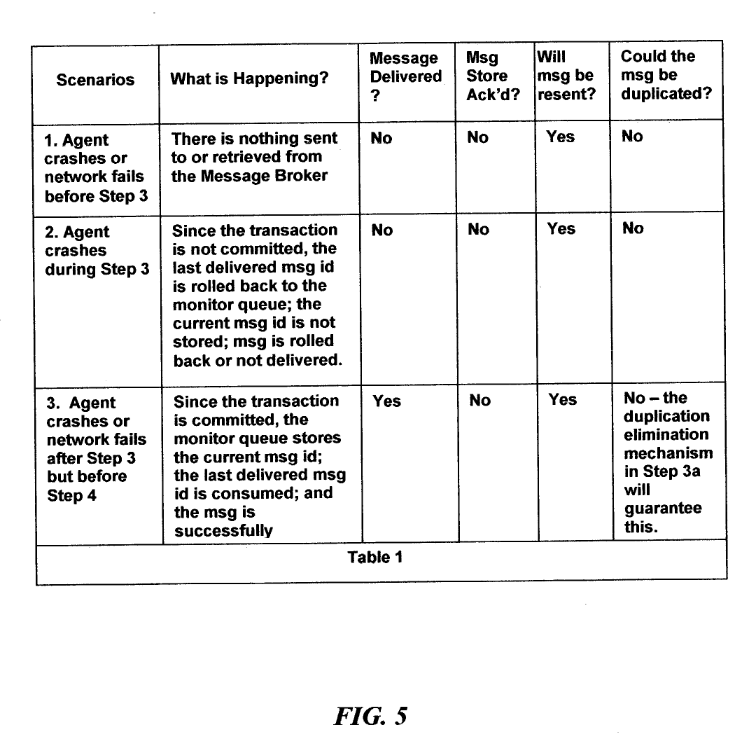

The messaging system 300 serves to protect messages from loss or replication in the event of a network failure. As can be seen from FIG. 5, the messaging system 300 is configured to prevent loss or replication no matter at what point in the processing steps a network failure occurs.

Table 1, as shown in FIG. 5, describes three different scenarios of a system failure and depicts how the messaging system 300 would prevent the delivery of duplicate messages. For purposes of this example, assume that there are four messages in the Message Store 102 queue: A, B, C, and D, in that order. Scenario 1 emulates a system crash occurring at Step 1 or Step 2. At this point in the processing, message A has been retrieved by the MTA 306, but the MTA 306 has not yet interacted with the Message Broker 304 (this occurs in Step 3). Therefore no message has been delivered and the Message Store 102 has not been ACK'd. Message A is still retained in the Message Store 102 queue, first in line, so to speak, so it will be retrieved by the MTA 306 once again when the system comes up, and successfully delivered.

In Scenario 2 we see what happens when there is a system failure sometime during Step 3. In this scenario Message B has been retrieved by the MTA 306 and the MTA 306 has begun processing it. At the time of the crash, the MTA 306 could be performing Steps 3a (retrieving the message id from the Monitor Queue 310), 3b (sending message identifier to the Monitor Queue 310), 3c (sending message A to Destination Queue 110), or 3d (committing the transaction). Step 3 has not finalized its last function of committing the transaction, and, as explained earlier, the transaction will fail and all of the work units making up this transaction will be undone. At this point, the last delivered message id (Message A) is rolled back to the Monitor Queue 310; the message id of Message B is rolled back from the Monitor Queue 310; and Message B is rolled back from the Destination Queue 110. The Message Store 102 is never sent an acknowledgment of the successful delivery of Message B, so Message B remains in the Message Store's 102 queue, waiting to be sent when the system comes up. When the system recovers from the crash, the MTA 306 will retrieve the next message to be processed in the Message Store 102 queue, which will be Message B. It will then compare the message id for Message B to the message id of the last successfully delivered message (Message A) and when the ids do not match, it will successfully deliver Message B and send an ACK to the Message Store 102. The Message Store 102 queue now contains Message C.

Scenario 3 emulates a system failure after Step 3, but before Step 4. In this scenario, Message C has been processed and the transaction has been committed (Step 3d); Message C is successfully delivered to the Destination Queue 110 (Step 3c); and the Monitor Queue 310 now stores the message id of Message C. The last step, Step 4, however, has not been activated, therefore the Message Store 102, since it has not received an ACK that Message C was successfully delivered, retains Message C in its queue of messages waiting to be sent. When the system recovers from the failure, the MTA 306 will once again poll the Message Store 102 for messages. It will then retrieve the first message in the queue (Message C) and begin processing this message. Once it begins the processing as shown in Step 3 and compares the message id of Message C with the message id of the last successfully delivered message in the Monitor Queue 310 (which is Message C), it will find a match and skip the rest of the processing of Step 3. Since it does not commit the transaction (in Step 3d) the transaction will be rolled back, which will roll back the message id of Message C to the Monitor Queue, then go on to Step 4 where the MTA 306 will send an ACK to the Message Store 102. When the Message Store 102 receives the ACK it will remove Message C from its queue. This assures that Message C is delivered once and only once to its destination.

All that is required for this Messaging System 300 to work is a server with transactional ability configured according to the invention. This transactional server can be a third party server. The preferred implementation will use a Java Messaging Service (JMS) server because the JMS system currently has the transactional ability required to implement the messaging system 300. The server may be implemented in one of two products: an interchange server or an adapter, or it could be distributed between the two. An interchange server comprises a hub in a hub-and-spoke enterprise application integration (EAI) system such as that provided by International Business Machines WebSphere® solutions. An adapter comprises the spoke in the hub-and-spoke EAI system. The adapter enables communication between two different applications.

Another preferred, but not required, implementation of this Messaging System 300 would be a modification to IBM's current MQSeries messaging product. This product already has the capability to recognize and handle the acknowledgement function at the Message Store. Those skilled in the art will appreciate that other implementations of the concepts of the invention are also possible.

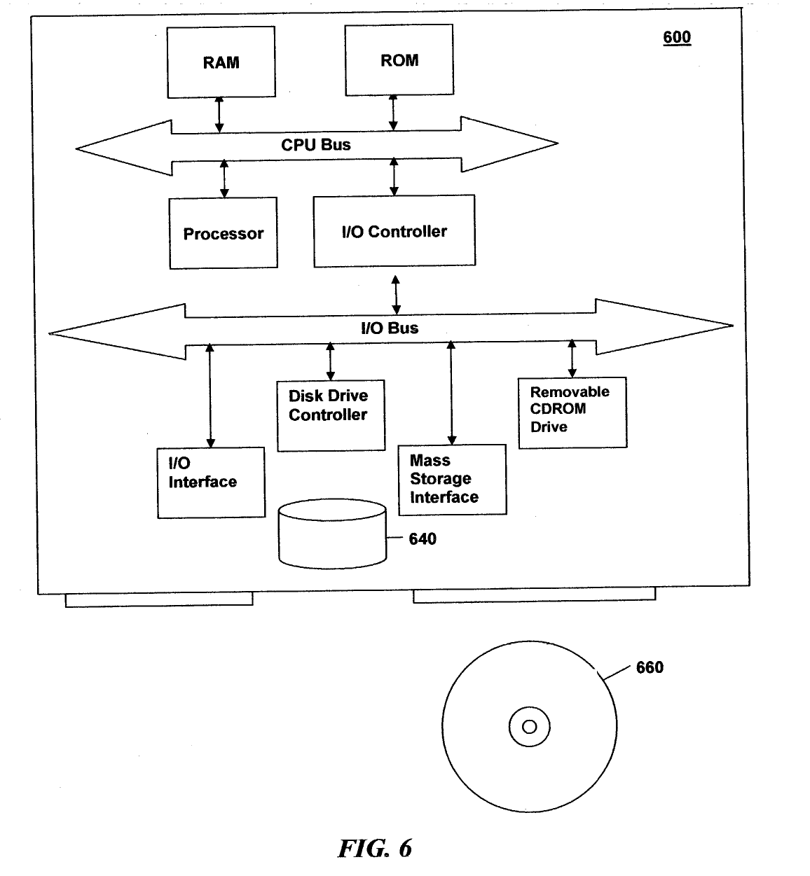

The messaging system 300 could be implemented as a hardware product, as shown in FIG. 6. The hardware product of FIG. 6 illustrates an implementation of the invention wherein all of the components are incorporated in a single information processing machine 600. The components of machine 600 are conventional parts of a common information processing apparatus such as an enterprise server. Those skilled in the art will appreciate that the block diagram of FIG. 6 illustrates a highly-simplified information processing system and other well-known lower-level components will be required to implement the operation of machine 600. The machine 600 comprises any of several well-known operating systems, such as AIX™ or Linux. In the preferred embodiment, the logic for performing a method or any of the methods according to the invention is stored in a computer readable medium, such as a compact disc (CD), or set of compact discs 660 and downloaded for storage in mass storage media such as hard disk drive 640. Those skilled in the art will also appreciate that the logic for implementing the invention can likewise be downloaded from a network such as the internet. Other embodiments could distribute the functionality of the present invention among various machines similar or identical to machine 600, without departing from the spirit and scope of the invention.

Therefore, while there has been described what is presently considered to be the preferred embodiment, it will be understood by those skilled in the art that other modifications can be made within the scope of the claimed invention.

We claim:

1. A method for preventing delivery of duplicate messages in a message system, wherein each message comprises a unique message identifier; the method comprising the steps of:
polling a message store for messages;
retrieving from the message store at least one message;
processing the at least one message;
retrieving a message identifier from a monitor queue in a transactional server, the message identifier corresponding to the last successfully delivered message; and
comparing the message identifier retrieved from the monitor queue to the message identifier of the message retrieved from the message store.

2. The method of claim 1 wherein if the compared message identifiers do not match the method further comprises the steps of:
sending the at least one message retrieved from the message store to a destination queue in a message broker; and
sending to the monitor queue the unique identifier of the last message successfully delivered.

3. The method of claim 1 wherein if the compared message identifiers match, the method further comprises the step of:
removing the at least one message from the message store upon acknowledgement that the message was successfully delivered.

4. The method of claim 1 wherein if the compared message identifiers match, the method further comprises the step of:
tagging the at least one message from the message store for non-delivery upon acknowledgement that the message was successfully delivered.

5. The method of claim 1 wherein the monitor queue operates in a transactional message broker server, operating according to the Java Messaging Service application program interface.

6. The method of claim 5 wherein the message store operates in the same message broker server as the monitor queue, according to the Java Messaging Service application program interface.

7. A message system wherein each message comprises a unique identifier that identifies itself from adjacent messages, the message system comprising:
a message transfer agent for processing messages, comprising logic for:
retrieving a message from a message store; and
comparing the unique identifier for the retrieved message to the unique identifier for the message which was last successfully delivered; and
if the compared identifiers do not match, sending the retrieved message to a transactional server for storage in a destination queue; and sending the unique identifier for the retrieved message to a monitor queue for storage in a monitor queue in a transactional server.

8. The message system of claim 7 further comprising:
a message broker for receiving messages sent by the message store, comprising:
the destination queue for storing messages to be delivered to designated recipients; and
the monitor queue for storing the unique identifier for the last successfully delivered message.

9. The message system of claim 7, wherein the message transfer agent further comprises logic for acknowledging to the message store the transmission of the retrieved message, so that the message store does not serve the message another time, if the compared identifiers match.

10. The message system of claim 7, further comprising a message store for storing source messages.

11. The message system of claim 7 comprising a Java Messaging Service server comprising the monitor queue and the destination queue.

12. A transactional server comprising:
a message broker for receiving messages sent from a message store and for serving the messages on recipients, wherein the message broker comprises a delivery queue and a monitor queue for storing an identifier corresponding to the last message successfully delivered.

13. The transactional server of claim 12, further comprising:
an agent for performing the following logic: polling the message store for messages, receiving at least one message responsive to the polling; processing the at least one message;
and sending the at least one message to the message broker;
wherein the message server comprises a destination queue and a monitor queue for storing the message identifier for the last successfully delivered message; and
wherein the agent is configured to retrieve the identifier stored in the monitor queue and to compare the retrieved identifier with the identifier from the message retrieved from the message store, and acknowledging the message store so that the message store removes the message from storage if the retrieved identifier matches the current message retrieved from the message store.

14. The transactional server of claim 13, wherein the agent further comprises logic to send the current message identifier to the monitor queue and to send the current message to the destination queue if the retrieved identifier does not match the current message identifier from the message retrieved from the message store.

15. The transactional server of claim 12, comprising a Java Messaging Service server that comprises the message broker.

16. The transactional server of claim 12 further comprising the message store, which comprises a persistent storage system for storing source messages.

17. The transactional server of claim 12 wherein the message store comprises a Java Messaging Service queue for storing source messages.

18. The transactional server of claim 12 wherein the message store comprises a database table for storing the source messages.

19. A program product comprising instructions for causing a processor to:
poll a message store for messages directed to a specified receiver;
receive from the message store at least one message directed to the specified receiver;
process the at least one message;
receive, from a monitor queue, a message identifier for the last message successfully delivered to the specified receiver; and
compare the message identifier received from the monitor queue to the message identifier of the message received from the message store.

20. The program product of claim 19 further comprising the instruction of sending the at least one message received from the message store to a destination queue in a message broker if the compared message identifiers do not match.

21. The program product of claim 19 further comprising the instruction of sending the message identifier from the message retrieved from the message store to the monitor queue in a message broker if the compared message identifiers do not match.
